(19) United States
(12) Patent Application Publication
(10) Pub. No.: US 2025/0056495 A1
(43) Pub. Date: Feb. 13, 2025

(54) SYSTEMS AND METHODS FOR PREDICTING USER LOCATION FROM RADIO DATA OF TELECOMMUNICATION NETWORK

(71) Applicant: JIO PLATFORMS LIMITED, Ahmedabad (IN)

(72) Inventors: Shailesh KUMAR, Hyderabad (IN); Krusheel MUNNANGI, Bangalore (IN); Vinit LUDHANI, Surat (IN)

(73) Assignee: JIO PLATFORMS LIMITED, Ahmedabad (IN)

(21) Appl. No.: 18/720,118

(22) PCT Filed: Dec. 16, 2022
(86) PCT No.: PCT/IB2022/062362

§ 371 Date: Jun. 14, 2024

(30) Foreign Application Priority Data
Dec. 17, 2021 (IN) 202121059023

(51) Int. Cl. H04W 64/00; G01S 19/46

(52) U.S. Cl. CPC H04W 64/006; G01S 19/46

(57) ABSTRACT

Present disclosure generally relates to location tracking and communication systems. More particularly, the present disclosure relates to systems and methods for predicting user location from radio data of telecommunication network. The system may utilize Global Positioning System (GPS) data along with Radio Frequency (RF) data obtained from interactions between the first computing device and network elements such as cells. The RF data along with the GPS data may be used for learned distance prediction models in AI engine. When the first computing device may be latched to a cell, the system via the first computing device can observe one or more neighbour cells. To estimate location of the user, predicted distances from cells and grids that can be served from each of cells may be used by system to estimate location of the user. System may use predicted distance from different cells to estimate the location of the user.

### FIELD OF INVENTION

The embodiments of the present disclosure generally relate to location tracking and communication systems. More particularly, the present disclosure relates to systems and methods for predicting user location from radio data of telecommunication network.

### BACKGROUND OF THE INVENTION

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

In general, availability of Global Positioning System (GPS) data may be scarce as users of mobile equipment may not provide permissions to share the GPS data or the mobile equipment may not be enabled with GPS. In case, the GPS is not enabled in the mobile equipment then there may be difficulty in obtaining the location of the user. There are approaches which utilize GPS data and also there are methods which may predict the accuracy of the GPS location. However, there may be no method to obtain the GPS location of the user, when the GPS is not enabled in the mobile equipment.

There is therefore a need in the art to provide systems and methods for predicting user location from radio data of telecommunication network, that can overcome the shortcomings of the existing prior art.

### OBJECTS OF THE PRESENT DISCLOSURE

Some of the objects of the present disclosure, which at least one embodiment herein satisfies are as listed herein below.

An object of the present disclosure is to provide systems and methods for predicting user location from radio data of telecommunication network.

Another object of the present disclosure is to improve location estimate of user based on radio data from telecommunication networks, and compensates for errors in Timing Advance (TA) and Reference Signal Received Power (RSRP) due to various factors such as reflections and attenuation of signal due to clutter, characteristics of user equipment, and the like.

An object of the present disclosure is to estimate the distance correction factors associated with a device, location or other factors in the context of associated cell to which user is latched to or corresponding neighbour cells.

Another object of the present disclosure is to estimate user location using the data available from user equipment interaction with telecommunication networks such as 4G, 5G, Wi-Fi networks etc or sensing of combination of above network data by user equipment.

Another object of the present disclosure is to use machine learned models to estimate the user's distance from cell tower and an iterative triangulation technique to estimate user location based on predicted distance.

Yet another object of the present disclosure is to help in improving the accuracy of estimated user location. Improved estimates of user location can be used in obtaining a better accuracies and performance of downstream systems such as demand prediction, tilt optimization, and the like.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure provides a system for predicting user location from radio data of a telecommunication network. The system may include one or more processors operatively coupled to one or more first computing devices associated with one or more users. The one or more first computing devices may be communicatively coupled to one or network elements (cells) of the telecommunication network. Further, the one or more processors may execute a set of executable instructions that are stored in a memory, upon execution of which, the one or more processors may cause the system to receive a set of data packets pertaining to interactions between the one or more first computing devices and the one or more cells, the set of data packets being received for a predefined period of time. The system may be configured to extract a first set of attributes from the received set of data packets, the first set of attributes pertaining to Global Positioning System (GPS) data of the one or more first computing devices and extract a second set of attributes from the received set of data packets, the second set of attributes pertaining to Radio Frequency (RF) data of the one or more first computing devices. Based on the extracted first and second set of attributes, the system may be configured to collect, using an artificial intelligence (AI) engine associated with the one or more processors, a training data to generate a distance prediction model and train, using the AI engine, the distance prediction model using the training data to predict a distance of the one or more users from a cell tower associated with the one or more cells.

In an embodiment, when a first computing device is latched to a cell, the system may be configured to observe via the first computing device one or more neighbour cells associated with the first computing device.

In an embodiment, the distance prediction model may predict a distance of a user associated with the first computing device from each of the one or more neighbour cells.

In an embodiment, the system may be configured to identify one or more grids in a coverage area of each of the one or more cells from the collected training data.

In an embodiment, the system may be configured to estimate a location of the user based on the predicted distance from the one or more cells and the one or more grids identified.

In an embodiment, the system may be configured to estimate the location of the user based on a predicted distance from one or more random cells that get associated with the first computing device.

In an embodiment, the system may be configured to estimate one or more correction factors in prediction of the distance, and the one or more correction factors may be associated with one or more aspects such as one or more cells, one or more first computing devices, and one or more geohash values of the one or more cells.

In an embodiment, the system may be configured to iteratively process the collected training data to learn the models used to estimate latitude and longitude of the user associated with the first computing device.

In an embodiment, the system may be configured to be remotely monitored and ensure that the collected training data, a set of execution steps for implementation of the collected training data and the system may be secured.

In an embodiment, the system may be further configured to meticulously acquire collected training data and deposit in a cloud-based data lake to for further processing.

In an aspect, the present disclosure provides a user equipment (UE) in a telecommunication network. The user equipment may include a processor and a receiver. The processor may be operatively coupled to one or more first computing devices associated with one or more users, the one or more first computing devices communicatively coupled to one or network elements (cells) of the telecommunication network, and the processor may execute a set of executable instructions that are stored in a memory, where the processor is communicatively coupled to one or more processors in a system. The one or more processor are configured to receive a set of data packets pertaining to interactions between the one or more first computing devices and the one or more cells, the set of data packets being received for a predefined period of time. The one or more processors may further extract a first set of attributes from the received set of data packets, the first set of attributes pertaining to Global Positioning System (GPS) data of the one or more first computing devices and extract a second set of attributes from the received set of data packets, the second set of attributes pertaining to Radio Frequency (RF) data of the one or more first computing devices. Based on the extracted first and second set of attributes, the one or more processors may be configured to collect, using an artificial intelligence (AI) engine associated with the one or more processors, a training data to generate a distance prediction model and train, using the AI engine, the distance prediction model using the training data to predict a distance of the one or more users from a cell tower associated with the one or more cells.

In an aspect, the present disclosure provides a method for predicting user location from radio data of a telecommunication network. The method may include the steps of receiving, by one or more processors, a set of data packets, said set of data packets pertaining to interactions between one or more first computing devices and one or more cells, the set of data packets being received for a predefined period of time. The one or more processors may be operatively coupled to the one or more first computing devices associated with one or more users, the one or more first computing devices being communicatively coupled to the one or network elements (cells) of the telecommunication network. The one or more processors may execute a set of executable instructions that are stored in a memory. The method may further include the steps of extracting, by the one or more processors, a first set of attributes from the received set of data packets, the first set of attributes pertaining to Global Positioning System (GPS) data of the one or more first computing devices and extracting, by the one or more processors, a second set of attributes from the received set of data packets, the second set of attributes pertaining to Radio Frequency (RF) data of the one or more first computing devices. Based on the extracted first and second set of attributes, the method may include the step of collecting, using an artificial intelligence (AI) engine associated with the one or more processors, a training data to generate a distance prediction model, and training, using the AI engine, the distance prediction model using the training data to predict a distance of the one or more users from a cell tower associated with the one or more cells.

### BRIEF DESCRIPTION OF DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that invention of such drawings includes the invention of electrical components, electronic components or circuitry commonly used to implement such components.

FIG. 1 illustrates an exemplary network architecture in which or with which proposed system of the present disclosure can be implemented, in accordance with an embodiment of the present disclosure.

FIG. 2A illustrates an exemplary block diagram representation of proposed system/Artificial Intelligence (AI) engine for predicting user location from radio data of telecommunication network, in accordance with an embodiment of the present disclosure.

FIG. 2B illustrates an exemplary block diagram representation of a user equipment (UE) for predicting user location from radio data of telecommunication network, in accordance with an embodiment of the present disclosure.

FIG. 3A illustrates exemplary block diagram representation of a proposed system architecture, in accordance with an embodiment of the present disclosure.

FIG. 3B illustrates an exemplary schematic diagram representation of distance prediction models, in accordance with an embodiment of the present disclosure.

FIG. 4A illustrates a block diagram representation of inference pipeline, in accordance with an embodiment of the present disclosure.

FIG. 4B illustrates a block diagram representation of raw data processing and data cleaning method, in accordance with an embodiment of the present disclosure.

FIG. 4C illustrates a flow diagram representation of method for filtering records in LTE System Records (LSR) table, in accordance with an embodiment of the present disclosure.

FIG. 4D illustrates a flow diagram representation of method for computing correction factors for each cell, in accordance with an embodiment of the present disclosure.

FIG. 4E illustrates a flow diagram representation of method for computing a center of best grid, in accordance with an embodiment of the present disclosure.

FIG. 5A illustrates an exemplary graphical representation of cell coverage and coverage overlap, in accordance with embodiments of the present disclosure.

FIGS. 5B and 5C illustrate exemplary graphical representations of cumulative histogram of location prediction error and histogram of location prediction errors, respectively, in accordance with embodiments of the present disclosure.

FIG. 6 illustrates an exemplary computer system in which or with which embodiments of the present invention can be utilized, in accordance with embodiments of the present disclosure.

The foregoing shall be more apparent from the following more detailed description of the invention.

### DETAILED DESCRIPTION OF INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Embodiments of the present disclosure provides systems and methods for predicting user location from radio data of telecommunication network. The present disclosure improves location estimate of user based on radio data from telecommunication networks, and compensates for errors in Timing Advance (TA) and Reference Signal Received Power (RSRP) due to various factors such as reflections and attenuation of signal due to clutter, characteristics of user equipment, and the like. The present disclosure estimates the distance correction factors associated with a device, location or other factors in the context of associated cell to which user is latched to or corresponding neighbour cells. The present disclosure estimates user location using the data available from user equipment interaction with telecommunication networks such as 4G, 5G, Wi-Fi networks etc or sensing of combination of above network data by user equipment. The present disclosure uses machine learned models to estimate the user's distance from cell tower and an iterative triangulation technique to estimate user location based on predicted distance. The present disclosure helps in improving the accuracy of estimated user location. Improved estimates of user location can be used in obtaining a better accuracies and performance of downstream systems such as demand prediction, tilt optimization, and the like.

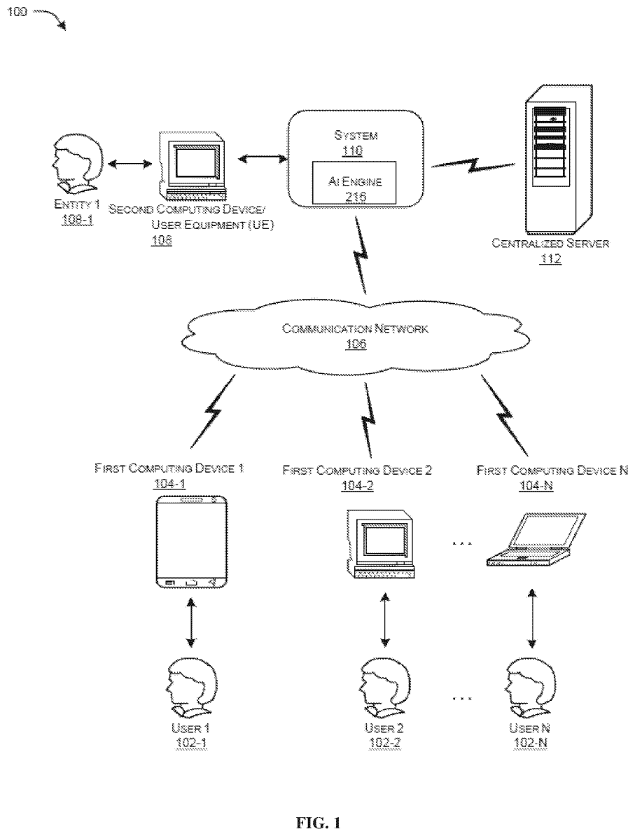

Referring to FIG. 1 that illustrates an exemplary network architecture for user location prediction system (100) (also referred to as network architecture (100)) in which or with which a system (110)/Artificial Intelligence (AI) engine (216) or simply referred to as the system (110)/AI engine (216) of the present disclosure can be implemented, in accordance with an embodiment of the present disclosure. As illustrated, the exemplary architecture (100) may be equipped with the system (110)/AI engine (216) for predicting location of users (102-1, 102-2, 102-3 . . . 102-N) (individually referred to as the user (102) and collectively referred to as the users (102)) associated with one or more first computing devices (104-1, 104-2 . . . 104-N) (individually referred to as the first computing device (104), or user device (104) and collectively referred to as the first computing devices (104) or user devices (104)), from radio data of telecommunication network (106). The telecommunication networks include, but are not limited to, Fourth Generation (4G). Fifth Generation (5G), Wireless Fidelity (Wi-Fi) networks, or sensing of combination of above network data, and the like. The system (110) may be further operatively coupled to a second computing device (108) (also referred to as user equipment (UE) (108)) associated with an entity (114). The entity (114) may include a company, an organisation, a university, a lab facility, a business enterprise, a defence facility, or any other secured facility. In some implementations, the system (110) may be working via the UE (108). The UE (108) can include a handheld device, a smart phone, a laptop, a palm top and the like.

The system (110) may be coupled to a centralized server (112). The centralized server (112) may also be operatively coupled to the one or more first computing devices (104) and the second computing devices (108) through the communication network (106). In some implementations, the system (110) may also be associated with the centralized server (112).

In an embodiment, the system (110) may utilize Global Positioning System (GPS) data along with Radio Frequency (RF) data obtained from interactions between the first computing device (104) and network elements such as cells. In an embodiment, the RF data along with the GPS data may be used for learned distance prediction models in AI engine (116). The models may be used to predict distance of the user from cell tower. The models may be AI models and/or Machine Learning (ML) models.

In an embodiment, when the first computing device (104) may be latched to a cell, the system (110) via the first computing device (104) can observe one or more neighbour cells. The models may be used to predict distance of user from each of the cell. Also grids in the coverage area of each of the cell may be identified from collected training data.

In an embodiment, to estimate the location of the user, predicted distances from cells and grids that can be served from each of the cells may be used by the system (110) to estimate the location of the user.

In an embodiment, the system (110) may use predicted distance from different cells to estimate the location of the user.

In an embodiment, the system may be configured to estimate one or more correction factors in prediction of the distance associated with one or more aspects such as one or more cells, one or more first computing devices, and one or more geohash values of the one or more cells.

In an embodiment, the system may be configured to iteratively process the collected training data to estimate latitude and longitude of the user associated with the first computing device.

In an embodiment, the system (110) may be a System on Chip (SoC) system but not limited to the like. In another embodiment, an onsite data capture, storage, matching, processing, decision-making and actuation logic may be coded using Micro-Services Architecture (MSA) but not limited to it. A plurality of microservices may be containerized and may be event based in order to support portability.

In an embodiment, the network architecture (100) may be modular and flexible to accommodate any kind of changes in the system (110) as proximate processing may be acquired towards re-estimating of stock. The system (110) configuration details can be modified on the fly.

In an embodiment, the system (110) may be remotely monitored and the data, application and physical security of the system (110) may be fully ensured. In an embodiment, the data may get collected meticulously and deposited in a cloud-based data lake to be processed to extract actionable insights. Therefore, the aspect of predictive maintenance can be accomplished.

In an exemplary embodiment, the communication network (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. A network may include, by way of example but not limitation, one or more of: a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, some combination thereof.

In another exemplary embodiment, the centralized server (112) may include or comprise, by way of example but not limitation, one or more of: a stand-alone server, a server blade, a server rack, a bank of servers, a server farm, hardware supporting a part of a cloud service or system, a home server, hardware running a virtualized server, one or more processors executing code to function as a server, one or more machines performing server-side functionality as described herein, at least a portion of any of the above, some combination thereof.

In an embodiment, the one or more first computing devices (104), the one or more second computing devices (108) may communicate with the system (110) via set of executable instructions residing on any operating system. In an embodiment, to one or more first computing devices (104), and the one or more second computing devices (108) may include, but not limited to, any electrical, electronic, electro-mechanical or an equipment or a combination of one or more of the above devices such as mobile phone, smartphone, Virtual Reality (VR) devices, Augmented Reality (AR) devices, laptop, a general-purpose computer, desktop, personal digital assistant, tablet computer, mainframe computer, or any other computing device, wherein the computing device may include one or more in-built or externally coupled accessories including, but not limited to, a visual aid device such as camera, audio aid, a microphone, a keyboard, input devices for receiving input from a user such as touch pad, touch enabled screen, electronic pen, receiving devices for receiving any audio or visual signal in any range of frequencies and transmitting devices that can transmit any audio or visual signal in any range of frequencies. It may be appreciated that the one or more first computing devices (104), and the one or more second computing devices (108) may not be restricted to the mentioned devices and various other devices may be used. A smart computing device may be one of the appropriate systems for storing data and other private/sensitive information.

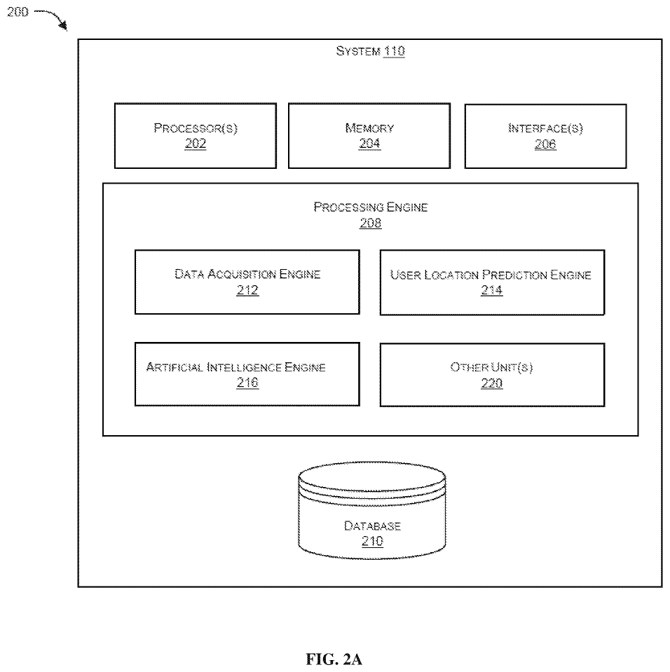

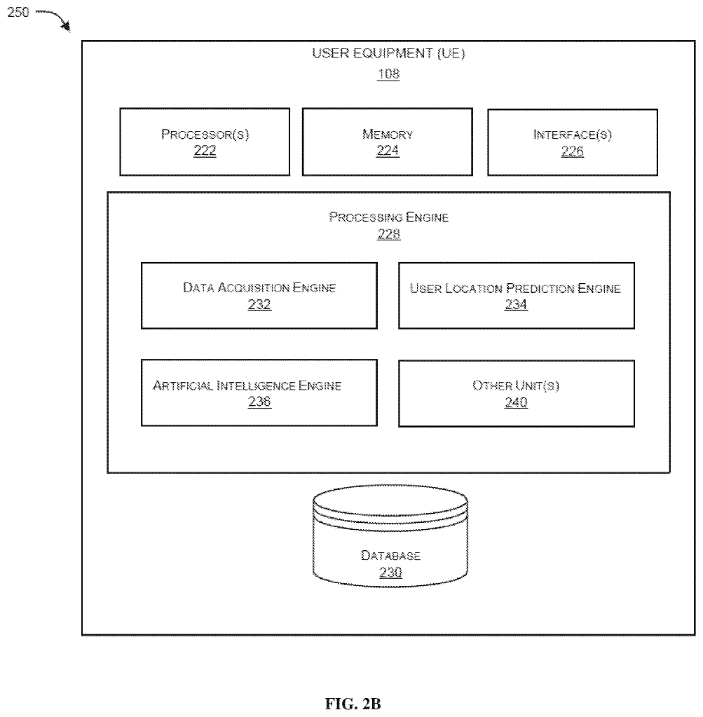

FIG. 2A illustrates an exemplary block diagram representation of proposed system (110)/Artificial Intelligence (AI) engine (216) for predicting user location from radio data of telecommunication network, in accordance with an embodiment of the present disclosure. In an aspect, the system (110) may include one or more processor(s) (202). The one or more processor(s) (202) may be implemented as one or more microprocessors, microcomputers, microcontrollers, edge or fog microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (110). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as RAM, or non-volatile memory such as EPROM, flash memory, and the like.

In an embodiment, the system (110) may include an interface(s) 206. The interface(s) (206) may comprise a variety of interfaces, for example, interfaces for data input and output devices, referred to as I/O devices, storage devices, and the like. The interface(s) (206) may facilitate communication of the system (110). The interface(s) (206) may also provide a communication pathway for one or more components of the system (110). Examples of such components include, but are not limited to, processing unit/engine(s) (208) and a database (210).

The processing unit/engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system (110)/AI engine (216) may comprise the machine-readable storage medium storing the instructions and the processing resource to execute the instructions, or the machine-readable storage medium may be separate but accessible to the system (110)/AI engine (216) and the processing resource. In other examples, the processing engine(s) (208) may be implemented by electronic circuitry.

The processing engine (208) may include one or more engines selected from any of a data acquisition engine (212), a distance prediction engine (214), and the AI engine (216) and other engines/units (218). The processing engine (208) may further edge based micro service event processing but not limited to the like.

FIG. 2B illustrates an exemplary representation (250) of the user equipment (UE) (108), in accordance with an embodiment of the present disclosure. In an aspect, the UE (108) may comprise a processor (222). The processor (222) may be an edge based processor but not limited to it. The processor (222) may be implemented as one or more microprocessors, microcomputers, microcontrollers, digital signal processors, central processing units, logic circuitries, and/or any devices that process data based on operational instructions. Among other capabilities, the processor(s) (222) may be configured to fetch and execute computer-readable instructions stored in a memory (224) of the UE (108). The memory (224) may be configured to store one or more computer-readable instructions or routines in a non-transitory computer readable storage medium, which may be fetched and executed to create or share data packets over a network service. The memory (224) may comprise any non-transitory storage device including, for example, volatile memory such as RAM, or non-volatile memory such as EPROM, flash memory, and the like.

In an embodiment, the UE (108) may include an interface(s) 226. The interface(s) 206 may comprise a variety of interfaces, for example, interfaces for data input and output devices, referred to as I/O devices, storage devices, and the like. The interface(s) 206 may facilitate communication of the UE (108). Examples of such components include, but are not limited to, processing engine(s) 228 and a database (230).

The processing engine(s) (228) may be implemented as a combination of hardware and programming (for example, programmable instructions) to implement one or more functionalities of the processing engine(s) (228). In examples described herein, such combinations of hardware and programming may be implemented in several different ways. For example, the programming for the processing engine(s) (228) may be processor executable instructions stored on a non-transitory machine-readable storage medium and the hardware for the processing engine(s) (228) may comprise a processing resource (for example, one or more processors), to execute such instructions. In the present examples, the machine-readable storage medium may store instructions that, when executed by the processing resource, implement the processing engine(s) (228). In such examples, the UE (108) may comprise the machine-readable storage medium storing the instructions and the processing resource to execute the instructions, or the machine-readable storage medium may be separate but accessible to the UE (108) and the processing resource. In other examples, the processing engine(s) (228) may be implemented by electronic circuitry.

The processing engine (228) may include one or more engines selected from any of a data acquisition engine (232), a distance prediction engine (234), and the AI engine (236) and other engines/units (238). The processing engine (228) may further edge based micro service event processing but not limited to the like.

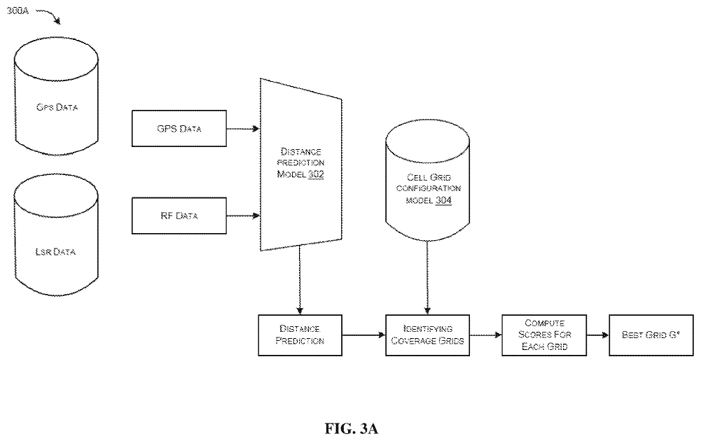

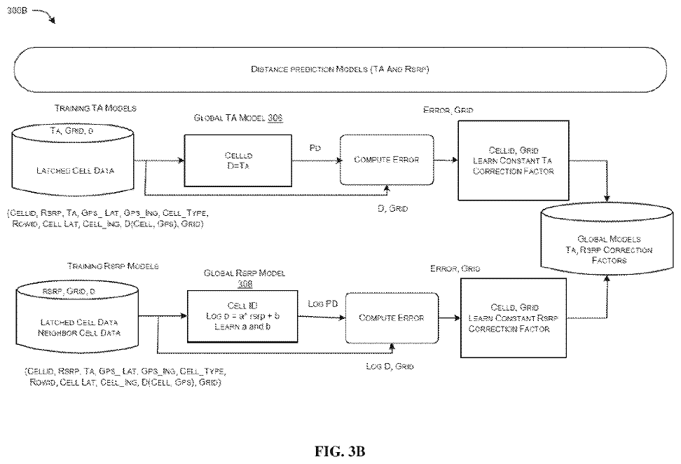

FIG. 3A illustrates exemplary block diagram representation of a proposed system architecture (300), in accordance with an embodiment of the present disclosure. The system architecture (300) may utilize the GPS data along with the RF data obtained from interactions between user equipment and network elements called cells. The RF data may include Local Shared Resources (LSR) data. The RF data along with the GPS data may be used for learned distance prediction models (302). The distance prediction models may be used to predict distance of the user (102) from a cell tower (not shown in FIGs.). The models may be AI models and/or Machine Learning (ML) models. When the first computing device (104) is latched to a cell, the system architecture (300) via the first computing device (104) can observe one or more neighbour cells. The models may be used to predict distance of user from each of the cell. Also grids in the coverage area of each of the cell may be identified from collected training data. Further, to estimate the location of the user, predicted distances from cells and grids that can be served from each of the cells may be used by the system (110)/system architecture (300) to estimate the location of the user. The system (110) may use predicted distance from different cells to estimate the location of the user.

The distance prediction model (302) may obtain data such as the GPS data, RF data/LSR data. The distance prediction model (302) may predict distance of the user 102 using the GPS data, RF data/LSR data. A cell grid configuration model (304) may identify coverage grids. Inference engine will compute score for each grid. Further, the inference engine (304) may determine best grid (G*). The distance prediction model (302) may use distance of the user (102) from cell tower as target variable. The distance prediction model (302) may learn different models one each for predicting distance using TA and RSRP. These models are learned at a cell level. These models do not capture the nuances associated with each location from the perspective a cell like clutter in the path from cell to the location. The distance prediction model (302) may model the effects of clutter and others using correction factor approach. The correction factor approach may be performed by a correction factor models. For each of the grids that can be served by a particular cell, and parameter type such as TA/RSRP a correction factor may be learned in the context of that cell to account for clutter between cell and location.

FIG. 3B illustrates an exemplary schematic diagram representation of distance prediction models, in accordance with an embodiment of the present disclosure. In an embodiment, the distance prediction models (302) may include a Timing Advance (TA) models and Reference Signal Received Power (RSRP) models. Both the TA model and RSRP model may be trained by the system (110). The latched cell data may include, but are not limited to, Cell Identity (ID), Reference Signal Received Power (RSRP) data. Timing Advance (TA) data, Global Position System (GPS) latitude data, GPS longitude data, cell type data, row Identity (ID), cell latitude, cell longitude, distance (cell, GPS), grid data. The latched cell data may be sent to a global TA model (306) to compute error in the predicted distance (pd) along with distance and grid data of the cell. The cell ID may be ECGI which is a global cell identifier. The local TA model (306) may learn constant TA correction factor from the cell ID and grid data. The TA correction factor may be stored in database.

In addition, training global RSRP models may include receiving latched cell data and neighbour cell data. A global RSRP model (308) may compute logarithm of distance. The logarithm of distance is computed using equation 1 below:

$$log d = a * rsrp + b \qquad Equation 1$$

Learn a and b. A log pd value may be used to compute error in the predicted distance along with log distance and grid data of the cell. The local RSRP model (308) may learn constant RSRP correction factor from the cell ID and grid data. The RSRP correction factor may be stored in database.

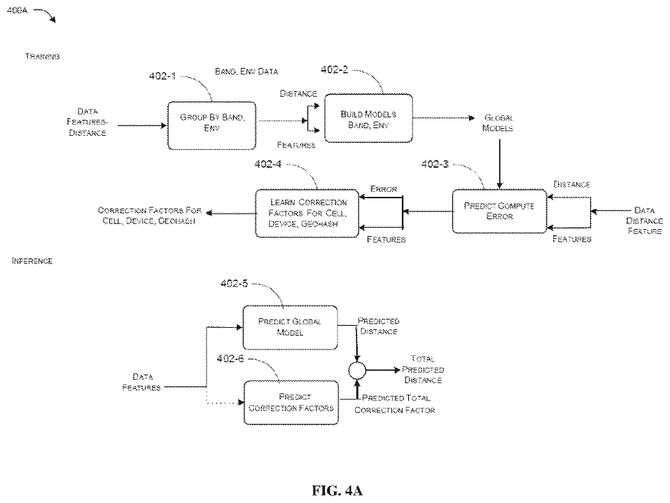

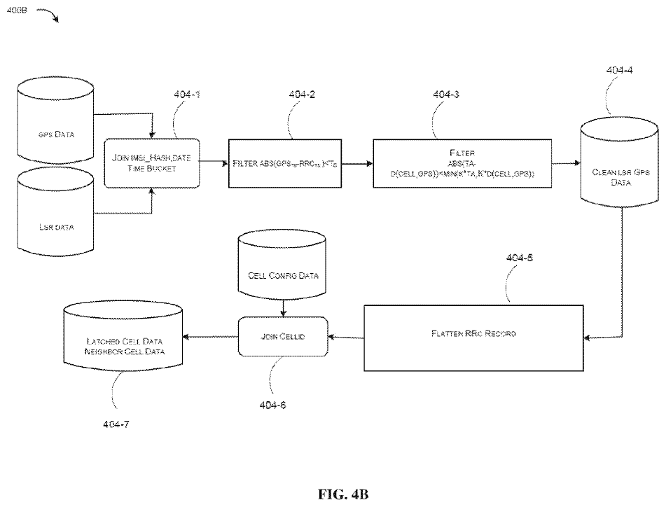

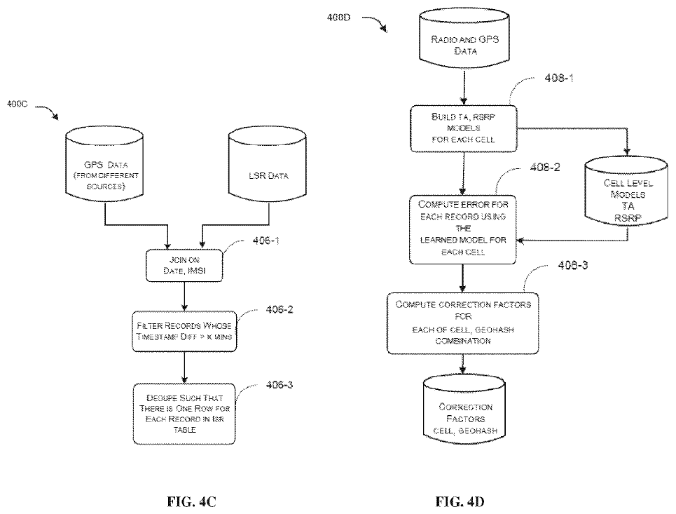

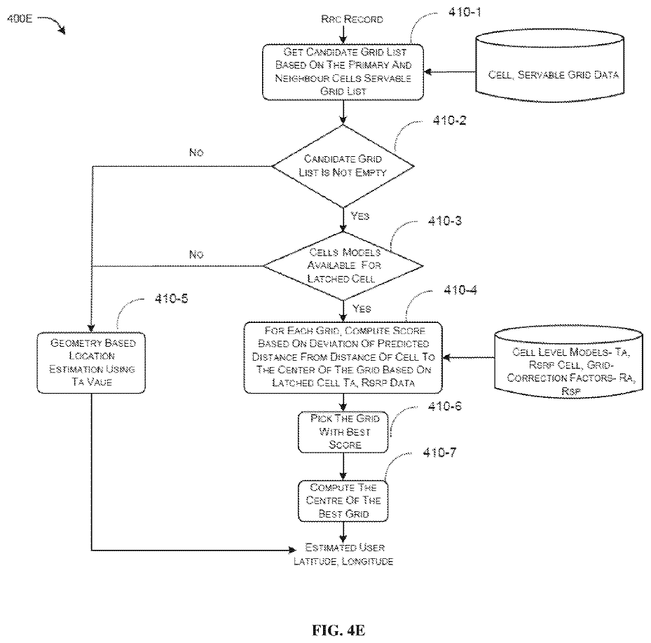

FIG. 4A illustrates a flow diagram representation of inference pipeline, in accordance with an embodiment of the present disclosure.

In the training stage, at step (402-1), the system (110) may receive data such as features and/or distance and group the data by band and env. At step (402-2), the system (110) may build models for band and env based on features and distance. At step (402-3), the system (110) may predict and/or compute error based on distance and features, in the global models. At step (402-4), the system (110) may learn correction factors for cell, device, geohash, based on the computed errors and features. The system (110) may output correction factors for cell, device, geohash.

In the inference stage, at step (402-5), the system (110) may predict using global model based on the data and features. The learned global model may output predicted distance. At step (402-6), the system (110) may predict correction factors and output predicted correction factors. The predicted distance and the predicted correction factors may be combined by the system (110) to output total predicted distance.

FIG. 4B illustrates a flow diagram representation of raw data processing and data cleaning method, in accordance with an embodiment of the present disclosure. For instance, users radio data may be enriched with GPS data to tag the location of the user (102) with particular interaction of the user (102) with the network which may be referred to as Radio Resource Control (RRC) record. Each interaction of user (102) may also be enriched with cell configuration data, distance of user from cell tower. Each RRC record contains parameters of interaction like RSRP, TA, Reference Signal Received Quality (RSRQ), Channel Quality Indicator (CQI).

At step (404-1), the system (110) may join GPS data and LSR data based on International Mobile Subscriber Identity (IMSI), date, time_bucket. At step (404-2), the system (110) may filter old GPS data and deduplicate RRC records using equation 2 below:

$$abs ( {gps}_{ts} - {rrc}_{ts} ) < t \qquad Equation 2$$

At step (404-3), the system (110) may filter bad TA records and GPS records using below equation 3:

$$abs ( ta - d ( cell , gps ) ) < min ( k * ta , K * d ( cell , gps ) ) \qquad Equation 3$$

At step (404-4), the system (110) may clean LSR data and GPS data. At step (404-5), the system (110) may flatten RRC record, which includes latched cell data neighbour cell data (cellid, rsrp, ta, gps_lat, gps_ing, cell_type rowid). At step (404-6), the system (110) may join cell configuration data using cell ID. At step (404-7), the system (110) may output latched cell data and neighbour cell data. The latched cell data and neighbour cell data may include, cellid, RSRP, TA, GPS_lat, GPS_Ing, cell_type, rowid, cell_lat, cell_Ing, d (cell, GPS), grid).

FIG. 4C illustrates a flow diagram representation of method for filtering records in LTE System Records (LSR) table, in accordance with an embodiment of the present disclosure. The cell coverage locations may include a cell that can service users with in certain distance from cell tower. Area which a cell can serve may be divided in to grids of dimension m×n meter2. Based on historical data, all the grids which can be served by a particular cell may be identified and stored so that it can be used during inference stage.

At step (406-1), the system (110) may join data and IMSI data based on receiving the GPS data from different sources and the LSR data. At step (406-2), the system (110) may filter records, whose time stamp difference is greater than K minutes. At step (406-3), the system (110) may dedupe data such that there is one row for each record in LSR table.

FIG. 4D illustrates a flow diagram representation of method for computing correction factors for each cell, in accordance with an embodiment of the present disclosure. At step (408-1), the system (110) may build TA, RSRP models for each cell based on radio data and GPS data. At step (408-2), the system (110) may compute error for each record using the learned model for each cell, based on cell level models such as TA model and RSRP model. At step (408-3), the system (110) may compute correction factors for each of cell, geohash combination. The system (110) may output correction factors cell and geohash.

FIG. 4E illustrates a flow diagram representation of method for computing best grid and center of best grid, in accordance with an embodiment of the present disclosure. At step (410-1), the system (110) may get candidate grid list based on the primary and neighbour cells servable grid list, based on cell, servable grid data. At step (410-2), the system (110) may check candidate list is not empty. If yes, then at step (410-3), the system (110) may check cells models available for latched cell. If yes, then at step (410-4), the system (110) may, for each grid, compute score based on deviation of predicted distance from distance of cell to the center of the grid based on latched cell ta, RSRP data, based on cell level models-TA, RSRP cell, grid-correction factors-TA, RSRP. If no, and if candidate grid list is empty then at step (410-5), the system (110) may estimate geometry-based location using TA value. At step (410-6), the system (110) may pick the grid with best score. At step (410-7), the system (110) may compute the center of best grid. The system (110) may output estimated user latitude and longitude. For, predicted distance to latitude and longitude estimation the system (110) may use the learned models of TA and RSRP along with correction factors to get an accurate estimate of distance of users from each of the cells in RRC record as shown in equation 4 below.

All the grids which can be served by a cell to which a user is latched and neighbour cells are identified. For each of the grids identified, predicted distance of the user from a cell is computed for each of the cell geohash combination using the models (TA and RSRP) and correction factors. Predicted distance of user in a grid and the distance of grid from cell tower are used to compute a score of users being present in the geohash. Grid having highest score is estimated as that grid in which user is present and center of the grid is estimated as the location of the user.

$$s ( {g}_{j} \vert RRC ) = {s}_{j} = ( \frac{1}{n} * {\sum }_{i} abs ( pd ( {c}_{i} , {rsrp}_{i} , {g}_{j} ) - d ( {c}_{i} , {g}_{j} ) ) + abs ( pd ( {ta}_{l} , {g}_{j} ) - d ) ( {c}_{l} , {g}_{j} ) ) ) \qquad Equation 4$$

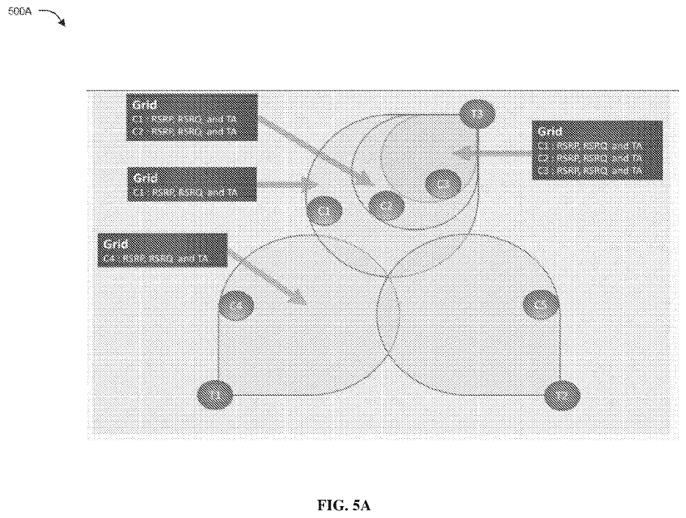

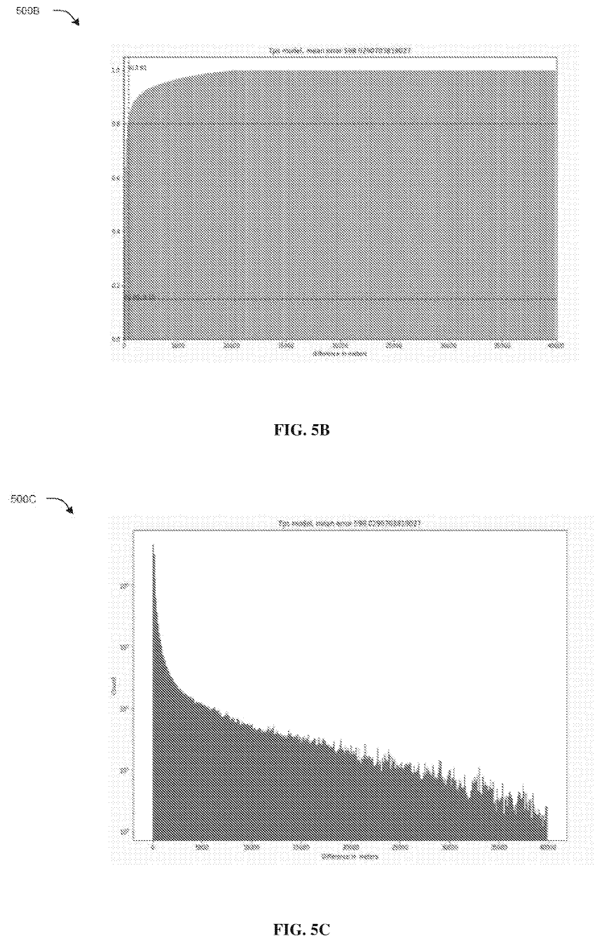

FIG. 5A illustrates an exemplary graphical representation of cell coverage and coverage overlap, in accordance with embodiments of the present disclosure. FIG. 5A depicts towers named T1, T2 and T3 and coverage area associated with cells on a tower. And rectangular boxes depict the information that may be available when a user is latched to particular cell. The mean error values are shown in below table 1.

TABLE 1

| | Mean Error |
|---|---|
| Approach | (in meters) |
| VO Data Clean Up + Geometric | 598 |
| Approach | |
| V1 Data Clean Up + Geometric | 354 |
| Approach | |
| Geometric Approach with Neighbor | 347 |
| Cells | |
| Global Local Models (TA) | 392 |
| Global + Local Models (RSRP) | 412 |
| Global + Local Models (TA + RSRP) | 317 |
| Geometric Approach with Neighbor | 347 |
| Cells | |
| Global Local Models (TA) with Grid | 385 |
| Refinement | |
| Global + Local Models (RSRP) with | 413 |
| Grid Refinement | |
| Global + Local Models (TA + RSRP) | 315 |
| with Grid Refinement | |
| Netscout | 309 |

FIGS. 5B and 5C illustrate exemplary graphical representations of cumulative histogram of location prediction error and histogram of location prediction errors, respectively, in accordance with embodiments of the present disclosure. FIGS. 5B and 5C depict the cumulative histogram and histogram of user location errors. Location error is defined as distance between reference latitude longitude and estimated latitude and longitude.

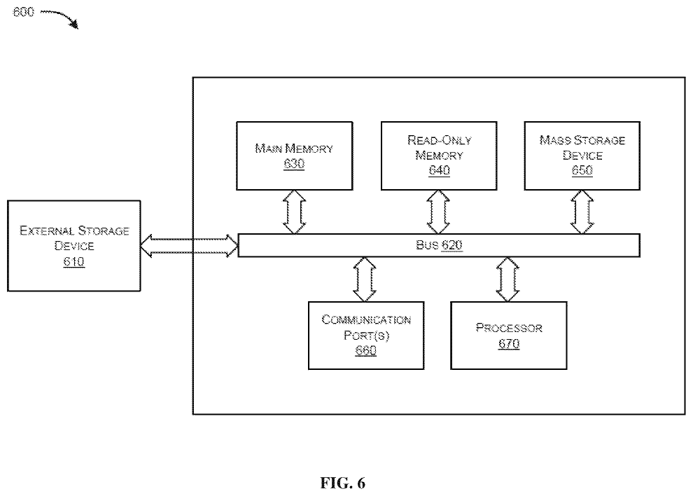

FIG. 6 illustrates an exemplary computer system (600) in which or with which embodiments of the present invention can be utilized, in accordance with embodiments of the present disclosure.

As shown in FIG. 6, computer system (600) can include an external storage device (610), a bus (620), a main memory (630), a read only memory (640), a mass storage device (650), communication port (660), and a processor (670). A person skilled in the art will appreciate that the computer system may include more than one processor and communication ports. Processor (670) may include various modules associated with embodiments of the present invention. Communication port (660) can be any of an RS-232 port for use with a modem-based dialup connection, a 10/100 Ethernet port, a Gigabit or 10 Gigabit port using copper or fibre, a serial port, a parallel port, or other existing or future ports. Communication port (660) may be chosen depending on a network, or any network to which computer system connects. Memory (630) can be Random Access Memory (RAM), or any other dynamic storage device commonly known in the art. Read-only memory (640) can be any static storage device(s). Mass storage (650) may be any current or future mass storage solution, which can be used to store information and/or instructions.

Bus (620) communicatively couples processor(s) (670) with the other memory, storage and communication blocks. Optionally, operator and administrative interfaces, e.g., a display, keyboard, and a cursor control device, may also be coupled to bus (620) to support direct operator interaction with a computer system. Other operator and administrative interfaces can be provided through network connections connected through communication port (660). Components described above are meant only to exemplify various possibilities. In no way should the aforementioned exemplary computer system limit the scope of the present disclosure.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

A portion of the disclosure of this patent document contains material which is subject to intellectual property rights such as, but are not limited to, copyright, design, trademark, IC layout design, and/or trade dress protection, belonging to Jio Platforms Limited (JPL) or its affiliates (herein after referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### ADVANTAGES OF THE PRESENT DISCLOSURE

The present disclosure provides systems and methods for predicting user location from radio data of telecommunication network.

The present disclosure improves location estimate of user based on radio data from telecommunication networks, and compensates for errors in Timing Advance (TA) and Reference Signal Received Power (RSRP) due to various factors such as reflections and attenuation of signal due to clutter, characteristics of user equipment, and the like.

The present disclosure estimates the distance correction factors associated with a device, location or other factors in the context of associated cell to which user is latched to or corresponding neighbour cells.

The present disclosure estimates user location using the data available from user equipment interaction with telecommunication networks such as 4G. 5G, Wi-Fi networks etc or sensing of combination of above network data by user equipment.

The present disclosure uses machine learned models to estimate the user's distance from cell tower and an iterative triangulation technique to estimate user location based on predicted distance.

The present disclosure helps in improving the accuracy of estimated user location. Improved estimates of user location can be used in obtaining a better accuracies and performance of downstream systems such as demand prediction, tilt optimization, and the like.

We claim:

1. A system (110) for predicting user location from radio data of a telecommunication network (106), said system (110) comprising:
one or more processors (202), said one or more processors (202) operatively coupled to one or more first computing devices (104) associated with one or more users (102), wherein the one or more first computing devices (104) are communicatively coupled to one or network elements (cells) of the telecommunication network (106), wherein the one or more processors (202) executes a set of executable instructions that are stored in a memory (204), upon execution of which, the one or more processors (202) causes the system (110) to:
receive a set of data packets, said set of data packets pertaining to interactions between the one or more first computing devices (104) and the one or more cells, wherein the set of data packets are received for a predefined period of time;
extract a first set of attributes from the received set of data packets, the first set of attributes pertaining to Global Positioning System (GPS) data of the one or more first computing devices (104);
extract a second set of attributes from the received set of data packets, the second set of attributes pertaining to Radio Frequency (RF) data of the one or more first computing devices (104);
based on the extracted first and second set of attributes, collect, using an artificial intelligence (AI) engine (216) associated with the one or more processors (202), a training data to generate a distance prediction model;
train, using the AI engine (216), the distance prediction model using the training data to predict a distance of the one or more users (102) from a cell tower associated with the one or more cells.

2. The system (110) as claimed in claim 1, wherein when a first computing device (104) of the one or more first computing devices (104) is latched to a cell, the system (110) is configured to observe, via the first computing device (104), one or more neighbour cells associated with the first computing device (104).

3. The system (110) as claimed in claim 2, wherein the distance prediction model predicts a distance of a user associated with the first computing device (104) from each of the one or more neighbour cells.

4. The system (110) as claimed in claim 1, wherein the system (110) is configured to identify one or more grids in a coverage area of each of the one or more cells from the collected training data.

5. The system (110) as claimed in claim 4, wherein the system (110) is configured to estimate a location of the one or more users (102) based on the predicted distance from the one or more cells and the identified one or more grids.

6. The system (110) as claimed in claim 5, wherein the system (110) is configured to estimate the location of the one or more users (102) based on a predicted distance from one or more random cells that get associated with the one or more first computing devices (104).

7. The system (110) as claimed in claim 5, wherein the system (110) is configured to estimate one or more correction factors in prediction of the distance, and wherein the one or more correction factors are associated with one or more aspects comprising at least one of the one or more cells, the one or more first computing devices (104), and one or more geohash values of the one or more cells.

8. The system (110) as claimed in claim 5, wherein the system (110) is configured to iteratively process the collected training data to estimate latitude and longitude of the one or more users (102) associated with the one or more first computing devices (104).

9. The system (110) as claimed in claim 1, wherein the system (110) is configured to be remotely monitored and ensure that the collected training data, a set of execution steps for implementation of the collected training data, and the system (110) is secured.

10. The system (110) as claimed in claim 1, wherein the system (110) is further configured to meticulously acquire the collected training data and deposit in a cloud-based data lake for further processing.

11. A user equipment (UE) (108) in a telecommunication network (106), said user equipment (108) comprising:
a processor (222) and a receiver, said processor (222) operatively coupled to one or more first computing devices (104) associated with one or more users (102), wherein the one or more first computing devices (104) are communicatively coupled to one or more network elements (cells) of the telecommunication network (106), wherein the processor (222) executes a set of executable instructions that are stored in a memory (224), wherein the processor (222) is communicatively coupled to one or more processors (202) in a system (110), and wherein the one or more processors (202) are configured to:
receive a set of data packets, said set of data packets pertaining to interactions between the one or more first computing devices (104) and the one or more cells, wherein the set of data packets are received for a predefined period of time;
extract a first set of attributes from the received set of data packets, the first set of attributes pertaining to Global Positioning System (GPS) data of the one or more first computing devices (104);
extract a second set of attributes from the received set of data packets, the second set of attributes pertaining to Radio Frequency (RF) data of the one or more first computing devices (104);
based on the extracted first and second set of attributes, collect, using an artificial intelligence (AI) engine (216), a training data to generate a distance prediction model;
train, using the AI engine (216), the distance prediction model using the training data to predict a distance of the one or more users (102) from a cell tower associated with the one or more cells.

12. A method for predicting user location from radio data of a telecommunication network (106), said method comprising:
receiving, by one or more processors (202), a set of data packets, said set of data packets pertaining to interactions between one or more first computing devices (104) and one or more cells, wherein the set of data packets are received for a predefined period of time, wherein said one or more processors (202) are operatively coupled to the one or more first computing devices (104) associated with one or more users (102), wherein the one or more first computing devices (104) are communicatively coupled to the one or more cells of the telecommunication network (106), wherein the one or more processors (202) executes a set of executable instructions that are stored in a memory (204);
extracting, by the one or more processors (202), a first set of attributes from the received set of data packets, the first set of attributes pertaining to Global Positioning System (GPS) data of the one or more first computing devices (104);
extracting, by the one or more processors (202), a second set of attributes from the received set of data packets, the second set of attributes pertaining to Radio Frequency (RF) data of the one or more first computing devices (104);
based on the extracted first and second set of attributes, collecting, using an artificial intelligence (AI) engine (216) associated with the one or more processors (202), a training data to generate a distance prediction model; and
training, using the AI engine (216), the distance prediction model using the training data to predict a distance of the one or more users (102) from a cell tower associated with the one or more cells.

13. The method as claimed in claim 12, wherein when a first computing device (104) of the one or more first computing devices (104) is latched to a cell, the method comprises observing, via the first computing device (104), one or more neighbour cells associated with the first computing device (104).

14. The method as claimed in claim 13, wherein the distance prediction model predicts a distance of a user associated with the first computing device (104) from each of the one or more neighbour cells.

15. The method as claimed in claim 12, wherein the method further comprises identifying, by the one or more processors (202), one or more grids in a coverage area of each of the one or more cells from the collected training data.

16. The method as claimed in claim 15, wherein the method further comprises estimating, by the one or more processors (202), a location of the one or more users (102) based on the predicted distance from the one or more cells and the identified one or more grids.

17. The method as claimed in claim 16, wherein the method further comprises estimating, by the one or more processors (202), the location of the one or more users (102) based on a predicted distance from one or more random cells that get associated with the one or more first computing devices (104).

18. The method as claimed in claim 16, wherein the method further comprises estimating, by the one or more processors (202), one or more correction factors in prediction of the distance, and wherein the one or more correction factors are associated with one or more aspects comprising at least one of the one or more cells, the one or more first computing devices (104), and one or more geohash values of the one or more cells.

19. The method as claimed in claim 16, wherein the method further comprises iteratively processing, by the one or more processors (202), the collected training data to estimate latitude and longitude of the one or more users (102) associated with the one or more first computing devices (104).

20. The method as claimed in claim 12, wherein the method further comprises remotely monitoring and ensuring, by the one or more processors (202), that the collected training data, a set of execution steps for implementation of the collected training data, and the method is secured.

21. The method as claimed in claim 12, wherein the method further comprises meticulously acquiring, by the one or more processors (202), the collected training data and deposit in a cloud-based data lake for further processing.
